(19) United States
(12) Patent Application Publication
(10) Pub. No.: US 2017/0032086 A1
(43) Pub. Date: Feb. 2, 2017

(54) TECHNIQUES FOR PROVIDING LIMITED FIDUCIARY SERVICES FOR SELF-FUNDED HEALTHCARE PLANS

(71) Applicant: The Phia Group, LLC, Braintree, MA (US)

(72) Inventors: Ron E. PECK, Natick, MA (US); Adam Russo, Hull, MA (US)

(21) Appl. No.: 15/219,769

(22) Filed: Jul. 26, 2016

Related U.S. Application Data
(60) Provisional application No. 62/197,641, filed on Jul. 28, 2015.
(60) Provisional application No. 62/240,852, filed on Oct. 13, 2015.

(51) Int. Cl. G06F 19/00; G06Q 40/08

(52) U.S. Cl. CPC G06F 19/328; G06Q 40/08

(57) ABSTRACT

The present disclosure is directed to techniques for providing fiduciary transfer services by a Plan Appointed Claim Evaluator (PACE). A health care plan fiduciary is contracted with the PACE to provide limited fiduciary services in the event a final, internal appeal of a denial of a service claim has been sought by a claimant. The claim has either a proposed in the case of a pre-service claim or an actual initial dollar amount in the case of a post-service claim. The claim is reviewed in view of the plan associated with the claim and applicable laws. In response to claim being denied by the PACE, and the denial of the claim being found arbitrary or capricious by an external independent review organization or a court, indemnifying the health care plan fiduciary is indemnified and any damage awarded beyond the initial amount sought by the claim are paid.

### CROSS-REFERENCE TO RELATED APPLICATIONS

The present non-provisional application claims the benefit of U.S. Provisional Patent Application Ser. No. 62/197,641 filed on Jul. 28, 2015, and of U.S. Provisional Patent Application Ser. No. 62/240,852 filed on Oct. 13, 2015, the entire contents of which are hereby incorporated by reference.

### TECHNICAL FIELD

The present disclosure generally relates to providing limited fiduciary transfer services for self-funded healthcare plans, and more particularly, to methods of providing contractually-based fiduciary transfer services during final, internal administrative appeals of claims, which may be submitted either pre- or post-medical services' provision, and facilitating subsequent external review of claim denials resulting therefrom.

### BACKGROUND INFORMATION

Self-funded health care is a form of self-insurance whereby an employer provides health or disability benefits to plan members with its own funds. This is in contrast to fully-insured plans where an employer contracts with an insurance company. In self-insurance, the employer assumes the risk of paying health claims based on claims filed by claimants. Claims are routinely submitted to the employer (or a plan administrator appointed by the employer to function as a fiduciary of the benefit plan, ensuring it is administered in strict accordance with the terms of the plan document) and/or a third party administrator (whose role is strictly ministerial and applicable to claims processing in accordance with the plan administrator's instructions). Claims are submitted both before medical services and/or supplies are obtained (e.g., pre-service claims), and following the provision of medical services and/or supplies by a medical service provider (e.g., post-service claims). In either case those claims get submitted and reviewed by a plan administrator or fiduciary to ensure, in the case of post-service claims, that payouts are in accordance with a plan document, and in the case of pre-service claims, that a payout would be available in accordance with a plan document if a proposed service or supply is received. The plan document includes provisions that resemble those found in a typical group health insurance policy offered by traditional insurance companies. However, and unless otherwise exempted, these plans must comport with rights and obligations under the Employee Retirement Income Security Act of 1974, also known as ERISA, as well as any other applicable state or federal law/regulation.

In some cases, employers seek to reduce the exposure of self-funding by purchasing stop loss insurance, or aggregate insurance, from an insurance provider. In a general sense, stop loss insurance is an umbrella policy that caps a plan-sponsor's liability within a specified time period. However, these types of insurance do not eliminate the administrative costs and the risks associated with administering plans. For this reason, as mentioned previously, companies who self-insure often contract with a third party for assistance in claims adjudication and payment. Third party administrators (TPA's) provide these and other services, but they do not insulate a company if an independent review organization (IRO) or court finds a claim was improperly denied, triggering the possibility of various legal and/or equitable penalties.

### BRIEF DESCRIPTION OF THE DRAWINGS

These and other features and advantages will be better understood by reading the following detailed description, taken together with the drawings wherein:

FIGS. 1A and 1B collectively illustrate one example method for providing fiduciary services by a Plan Appointed Claim Evaluator (PACE), in accordance with an embodiment of the present disclosure.

FIGS. 2A-2C collectively define one example method of a third party plan administrator (TPA) or plan fiduciary establishing a limited fiducial relationship with a PACE, in accordance with an embodiment of the present disclosure.

These and other features of the present embodiments will be understood better by reading the following detailed description, taken together with the figures herein described. The accompanying drawings are not intended to be drawn to scale. In the drawings, each identical or nearly identical component that is illustrated in various figures is represented by a like numeral. For purposes of clarity, not every component may be labeled in every drawing.

### DETAILED DESCRIPTION

As previously discussed, TPAs generally provide so-called “administrative only” services for self-funded healthcare plans. TPAs do not provide legal services related to claim adjudication, nor assume any risk related thereto. This means that a company who seeks to self-fund also assumes the risks that would otherwise be subsumed in traditional fully-insured plans. While large companies (1000+ employees) may have the financial resources and expertise to mitigate that risk, many small to medium-sized companies cannot. However, market trends show an explosion of self-funded growth for companies of all sizes. For example, from 2006 to 2011 the commonwealth of Massachusetts saw substantial growth in firms with 50-99 employees, from 54.4 percent to 67.2 percent; in firms with 100-999 employees, from 16.6 percent to 29.2 percent; and in firms with 1,000 or more employees, from 74.1 percent to 86.4 percent.

This is just one example of a growing trend. One challenge for such a trend is how to eliminate or otherwise mitigate the risk a TPA or plan fiduciary faces when opting to be self-insured. For example, a claim that is denied at a final administrative appeal, but is later found payable by an IRO or court, may subject the company itself to damages. Sometimes those damages can be triple the initial health claim amount.

Thus, in accordance with an embodiment, a method is disclosed for providing fiduciary services by a Plan Appointed Claim Evaluator (PACE), whereby the PACE assumes fiduciary duties related to final, internal administrative appeals of benefit denials, initially issued by the plan administrator (or TPA on the plan administrator's behalf) in response to a pre-service or post-service claim and/or first appeal. In particular, when a plan participant, or claimant, appeals an adverse benefit determination, and the appeal is the last one available to that participant (prior to submitting an external appeal to an IRO or filing a civil suit to appeal), the PACE will make the claims payment determination and assume the fiduciary financial risks related to fiduciary damages arising from or awarded due to arbitrary and capricious claim denial(s) and an applicable fiduciary breach.

The method for providing fiduciary services by a PACE is compatible with all presently existing self-funded health plans, regardless of the plan design. Generally, a self-funded plan is overseen by at least one plan fiduciary, whether that plan is a traditional network plan, utilizes reference-based pricing, carve-outs, or any other benefit payment model. The PACE assists the group, plan administrator, or any other named plan fiduciary to avoid making a determination that will later become invalid if appealed to an IRO or a court. The PACE helps to avoid the risk a plan fiduciary would otherwise have by ensuring that claims are correctly paid pursuant to the plan document. In such cases, the plan administrator's decisions are not further reviewed externally (e.g., by a court or other IRO) without first passing through the PACE, and thus arbitrary decision making, and resultant fiduciary breach, is eliminated, transferred or otherwise mitigated.

This does not mean the PACE assumes the role of a so-called Plan Administrator. Instead, the PACE operates in a limited fiduciary capacity upon a claimant filing a final, internal administrative appeal. The PACE is only provided authority at this stage to make determinations on final, internal administrative appeals, when such determinations include the most financial exposure to the self-insured company. In a general sense, once the PACE assumes authority, the burden “shifts” to them to operate as a fiduciary. This means that a PACE includes the necessary legal and technical experience to navigate complex legal and medical situations that do not necessarily have a clear path to resolution. Decisions made by the plan to deny will be reviewed by the PACE during the final, internal administrative appeal, after careful consideration of the plan document the claim was made against. The plan administrator can thus avoid making difficult fiduciary determinations, in response to final, internal administrative appeals, which have the potential to be scrutinized by an IRO (for non-grandfathered plans) or court of law (for either grandfathered or non-grandfathered plans). Thus, the PACE takes on liability for fiduciary damages that may result from a claim determination found to be based on arbitrary and/or capricious reasoning.

As generally referred to here, a claimant refers to a participant or member of the benefit plan, or entity acting on their behalf, authorized to submit claims to the Plan for processing, and/or appeal an Adverse Benefit Determination.

As generally referred to herein a final, internal appeal, or final administrative appeal, refers to the last internal appeal available to the claimant, after the claimant's pre-service or post-service claim has been filed with, and denied by, the applicable entity, which is then to be filed with the plan administrator, plan sponsor, and/or other named fiduciary assigned authority and the duty to otherwise handle appeals. Upon filing, adjudication and conclusion of this appeal, external review becomes available to the claimant by statute and/or otherwise in accordance with applicable terms found within the plan document and applicable law. The plan administrator, plan sponsor, and/or other named fiduciary assigned authority and the duty to otherwise handle appeals, generally reserves the right to allocate certain discretionary authority as it applies to adjudication of final appeals to the PACE.

A PACE, as generally referred to herein, refers to an entity appointed by the plan administrator, plan sponsor, and/or other named fiduciary assigned authority and the duty to otherwise handle appeals, with authority to make final, binding (insofar and to the same extent as a decision by the plan Administrator, plan Sponsor, and/or other named fiduciary assigned authority and the duty to otherwise handle appeals, would be deemed to be binding), claims processing decisions in response to final appeals. In instances where the plan administrator, plan sponsor, and/or other named fiduciary assigned authority and the duty to otherwise handle appeals, delegates fiduciary authority to the PACE, the PACE generally exercises the same level of discretionary authority as that which the plan administrator, plan sponsor, and/or other named fiduciary assigned authority and the duty to otherwise handle appeals, may otherwise exercise. In general, the PACE's fiduciary duties extend only to those determinations actually made by the PACE. The PACE may perform other tasks on behalf of and in consultation with the plan administrator, plan sponsor, and/or other named fiduciary assigned authority and the duty to otherwise handle appeals, but the PACE may only be deemed to be a fiduciary when making final determinations regarding plan coverage and claims examined via final, internal appeal. The PACE makes such determinations in accordance with the terms of the plan and applicable law, in light of the facts, law, medical records, and all other information submitted to the PACE.

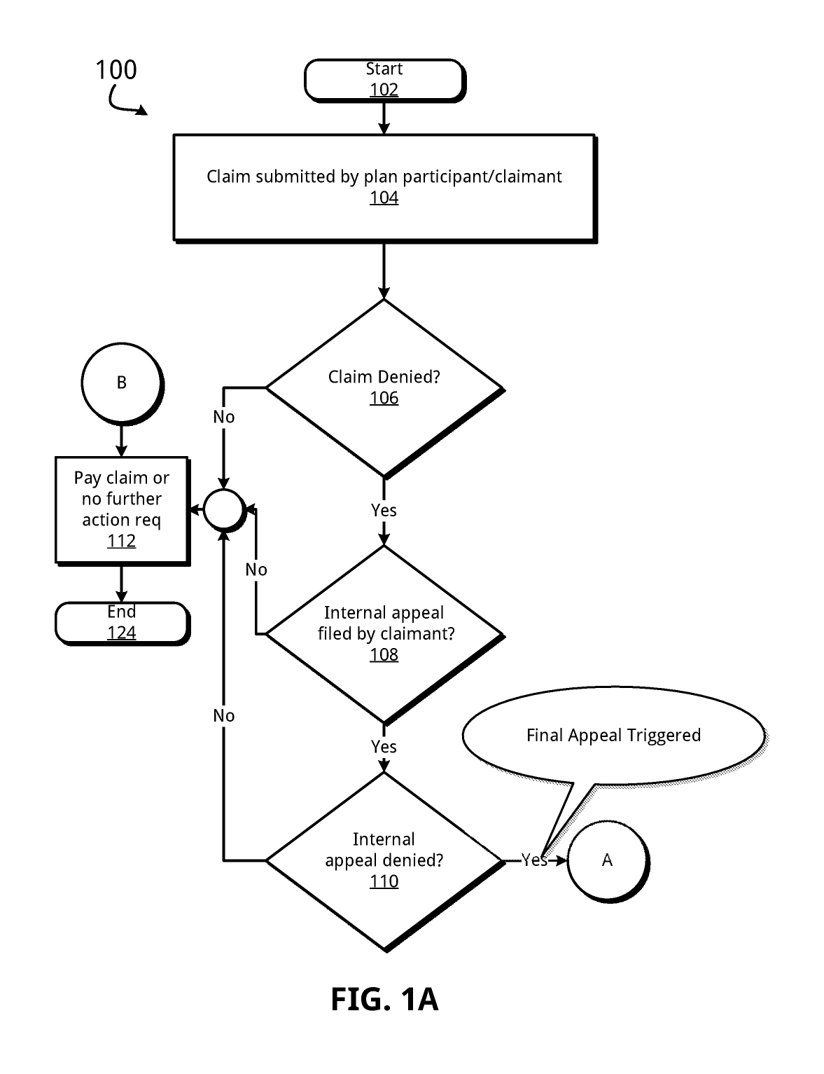

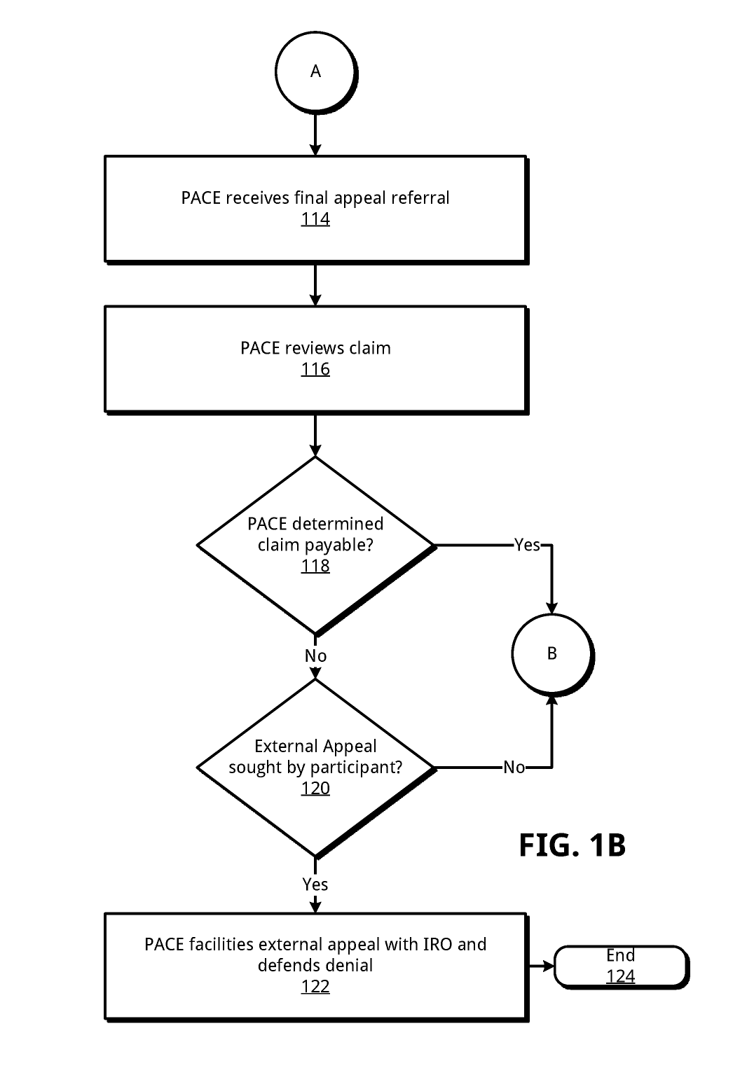

Now referring to the Figures, FIGS. 1A and 1B collectively illustrate one example method 100 for providing fiduciary services by a Plan Appointed Claim Evaluator (PACE), in accordance with an embodiment of the present disclosure. Method 100 begins in act 102.

In act 104, a claim is submitted by a plan participant, or claimant, either pre- or post-service. The claim may be related to one or more medical services, e.g., physical therapy, chemotherapy, surgery, specialist visits, mental health evaluations, and so on, and/or to one or more medical supplies, e.g., prosthetic limbs, motorized wheel chairs, medications, and so on.

In act 106, the plan administrator or other named plan fiduciary determines if the claim is not allowed or would not be allowed based on the provisions of the then in-effect plan and applicable law. If the claim is denied, method 100 continues to act 108. If the claim is allowed, the method continues to act 112 and the service is pre-certified (approved), or the claim for services provided is paid.

In act 108, the plan administrator or other named plan fiduciary determines if an internal appeal has been filed by the claimant regarding the denial of the claim in act 106. If no internal appeal has been filed, the method 100 continues to act 112, with no further action required. If an internal appeal was filed, the method continues to act 110.

In act 110, the plan administrator or other named plan fiduciary determines if the internal appeal should be denied. If the internal appeal is denied, the method 100 continues to act 114, and the final, internal appeal is triggered, which is also generally known as a final, internal administrative appeal. If the internal appeal is allowed (e.g., the service is pre-certified (approved) or the claim is found to be payable for service(s) already rendered), the method 100 continues to act 112, and the service is pre-certified (approved) or the claim or service(s) already rendered is paid.

In act 114, the PACE receives the final, internal administrative appeal referral. In act 116, the PACE reviews the claim in view of the then in-effect plan and applicable law. In act 118, the PACE determines if the proposed service should be payable, or the claim for services rendered should be paid. If the proposed service should be payable, or the claim for services rendered is payable, the method 100 continues to act 112, and the claim is paid. If the proposed service should not be payable or the claim for services already rendered is not payable, the method 100 continues to act 120.

In act 120, the PACE, in conjunction with the plan administrator or other named plan fiduciary, determines if an external appeal was sought by the claimant. Such external appeals could be by an IRO, or a court, depending on the plan-type and whether it was grandfathered or non-grandfathered. If an external appeal is sought by the claimant, the method 100 continues to act 122. Otherwise, the method 100 continues to act 112, and no further action is required.

In act 122, the PACE facilities the external appeal with IRO/court and defends the denial. In some cases, this includes providing legal counsel, legal strategy, expert testimony, documentary evidence, demonstrative evidence, and other factual evidence to support a finding that the denial was not arbitrary or capricious. In the event the claim is found payable by an external IRO/court, the benefit plan itself, plan sponsor, or other source of funds designated in the applicable plan document pays the claim. In the event the claim is found payable by an external IRO/court, and the denial of that claim was found to be arbitrary or capricious, the PACE pays the damages awarded under the in-effect statute. The damages may be treble damages, depending on the particular statute. Note that the damages are exclusive of the original dollar amount of the claim. The original claim amount is paid by the benefit plan itself, plan sponsor, or other source of funds designated in the applicable plan document. Thus, the PACE assumes limited fiducial responsibility in the event that such enhanced damages are awarded. The method 100 ends in act 124.

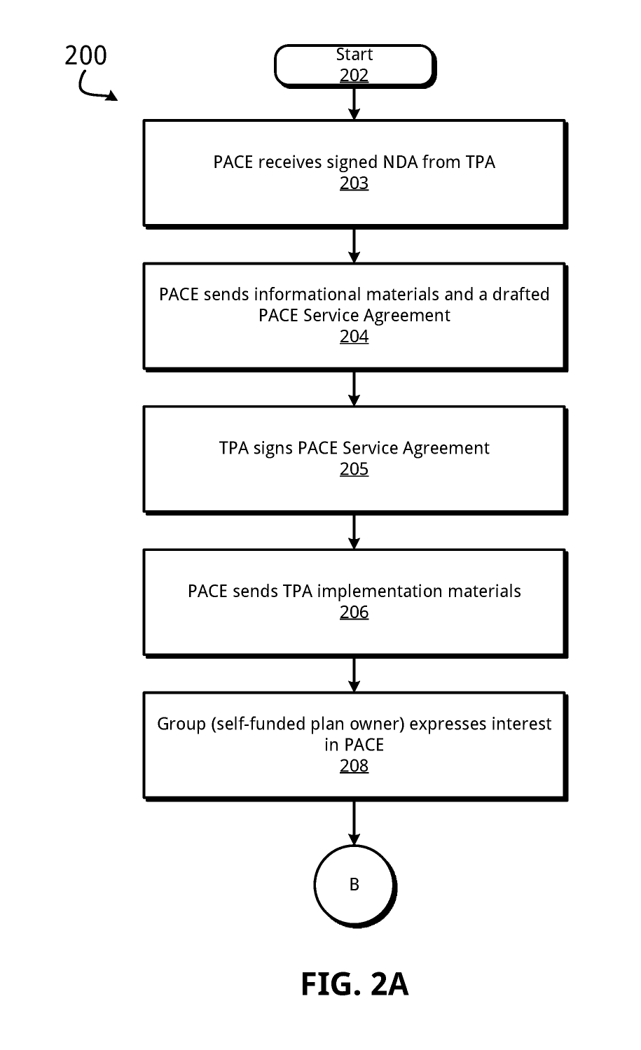

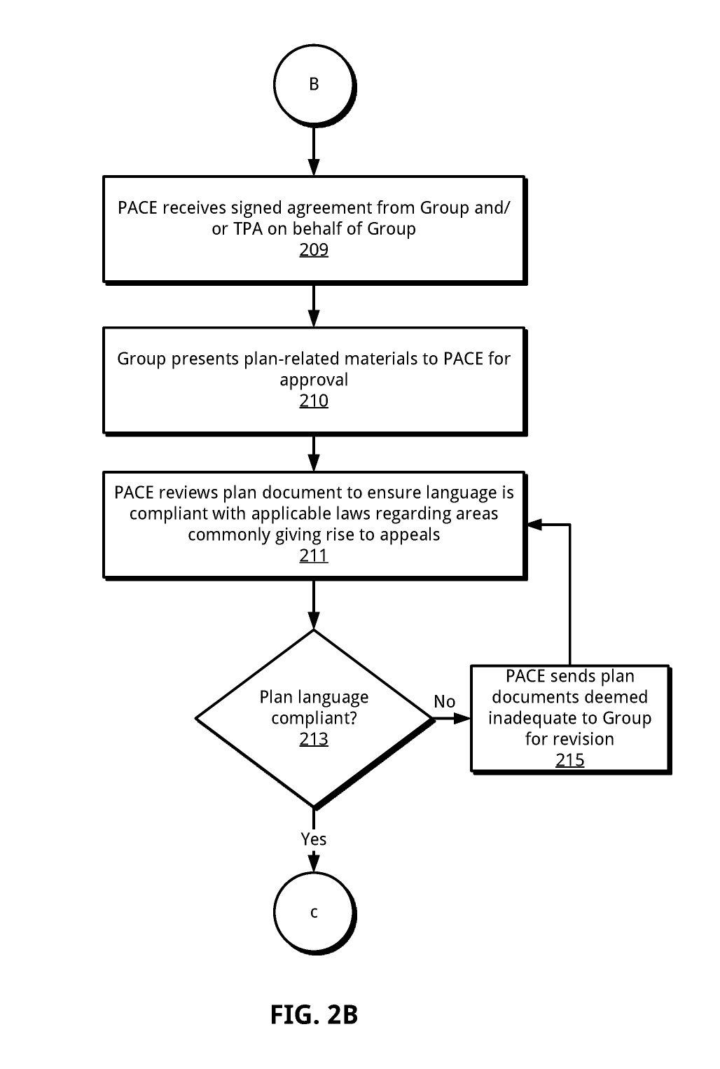

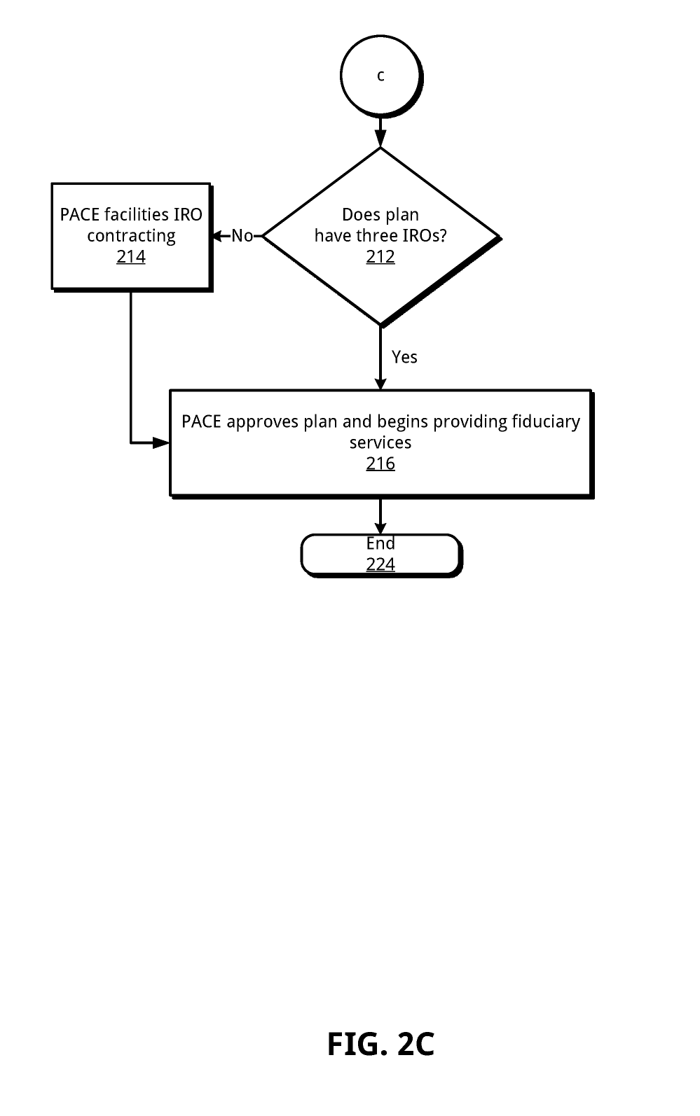

FIGS. 2A-2C collectively define one example method 200 of a third party plan administrator (TPA) or plan fiduciary establishing a limited fiducial relationship with a PACE, in accordance with an embodiment of the present disclosure. Method 200 begins in act 202. Note while the following references a TPA, a plan administrator or other named plan fiduciary are also equally applicable.

In act 203, the PACE optionally receives a signed non-disclosure agreement (NDA) from the TPA.

In act 204, the PACE sends informational materials along with a drafted PACE Service Agreement.

In act 205, the TPA signs or otherwise contracts with a PACE by signing a service agreement or equivalent thereof.

In act 206, the PACE sends TPA implementation material detailing the paperwork/process involved with allowing the PACE to act as a fiduciary when handling final appeals, and to provide the power to the PACE to handle those appeals. In particular, PACE provides details, such as example language, on how to modify a plan (or create a new one) to perfect or otherwise improve its claims and appeals language, and to utilize the PACE for final appeals. This language also informs plan participants/claimants that the PACE will be acting as the fiduciary for final, internal appeals. In one embodiment, the PACE provides software, or access to a remote computer process such as a website, that provides tools, examples, and tutorials for drafting plan language in an optimized fashion to facilitate using the PACE for final administrative appeals.

In act 208, the group, also known as the self-funded plan owner, expresses interest in utilizing the PACE for final, internal appeals. The group does this by mailing a correspondence to that effect to the applicable TPA, broker, or other intermediary with whom the PACE has an agreement, executing an agreement with the PACE and/or aforementioned TPA, broker, or other intermediary, or by utilizing software functionality within the software/remote process, as discussed above.

In act 209, PACE receives the signed agreement from Group and/or TPA on behalf of Group.

In act 210, the group presents the language of the plan-related materials to PACE for approval directly or through the aforementioned TPA, broker, or other intermediary.

In act 211, the PACE reviews the plan documents against applicable laws and regulations governing self-insured plans to ensure language is compliant, and in particular, compliant in those areas commonly giving rise to appeals.

In act 213, the PACE determines if the language in the documents is compliant, as discussed above. If the language is compliant, the method 200 continues to act 212. If the language is not compliant, the method continues to act 215.

In act 215, the PACE sends plan documents deemed inadequate back to Group for revision. In some cases this includes the PACE compliant language. The method 200 continues performance of acts 211 to 213 until the language is found compliant, and thus approved by the PACE.

In act 212, the PACE determines if the plan includes three (3) designated IROs. At the time of filing this application, applicable law requires three (3) and the disclosure should not be construed as limited in this regard. The particular number of required IROs may vary in accordance with applicable laws and requirements. If the plan includes three IROs, the method 200 continues to act 216. If the plan does not include three IROs, the method 200 continues to act 214.

In act 214, the PACE facilitates contracting of IROs to bring the plan into compliance.

In act 216, the PACE approves the plan and begins providing fiduciary services in the event of final appeals. The method 200 ends in act 224.

Although each of methods 100 and 200 are illustrated with particular steps performed in a particular sequence, this disclosure is not so limited. For instance, acts may be omitted, performed out of order, or otherwise augmented. For example, in one implementation, acts 203, 204 and 209 may not be performed.

In accordance with an aspect of the present disclosure, a method for providing limited fiduciary services by a Plan Appointed Claim Evaluator (PACE) is disclosed. The method comprising contracting with a health care plan fiduciary to provide limited fiduciary services when a final, internal appeal (FIA) of a denial of a claim has been sought by a claimant, the claim being associated with an initial dollar amount, reviewing, by the PACE, the claim in view of the plan associated with the claim and applicable laws, and in response to claim being denied by the PACE, and the denial of the claim being found arbitrary or capricious by an external independent review organization (IRO) or a court, indemnifying the health care plan fiduciary and paying any damage awarded beyond the initial dollar amount sought by the claim.

In accordance with another aspect of the present disclosure a method for providing limited fiduciary services by a Plan Appointed Claim Evaluator (PACE) is disclosed. The method comprising contracting with a health care plan fiduciary to provide limited fiduciary services when a final, internal appeal (FIA) of a denial of a pre-service or post-service claim has been sought by a claimant, the claim being associated with an initial dollar amount, reviewing, by the PACE, the claim in view of the plan associated with the claim and applicable laws, and in response to claim being denied by the PACE, and the denial of the claim being found arbitrary or capricious by an external independent review organization (IRO) or a court, indemnifying the health care plan fiduciary and paying any damage awarded beyond the initial dollar amount sought by the claim.

In accordance with yet another aspect of the present disclosure, a method for providing limited fiduciary services by a Plan Appointed Claim Evaluator (PACE) is disclosed. The method comprising contracting with a health care plan fiduciary to provide limited fiduciary services when a final, internal appeal (FIA) of a denial of a pre-service or post-service claim has been sought by a claimant, the claim being associated with an initial dollar amount, reviewing, by the PACE, the claim in view of the plan associated with the claim and applicable laws, and in response to claim being denied by the PACE, and the denial of the claim being found arbitrary or capricious by an external independent review organization (IRO) or a court, indemnifying the health care plan fiduciary and paying any damage awarded beyond the initial dollar amount sought by the claim up to treble damages if awarded by the adjudicative body.

While the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. Modifications and substitutions by one of ordinary skill in the art are considered to be within the scope of the present disclosure, which is not to be limited except by the following claims.

What is claimed is:

1. A method for providing limited fiduciary services by a Plan Appointed Claim Evaluator (PACE), the method comprising:
contracting with a health care plan fiduciary to provide limited fiduciary services when a final, internal appeal (FIA) of a denial of a claim has been sought by a claimant, the claim being associated with an initial dollar amount;
reviewing, by the PACE, the claim in view of the plan associated with the claim and applicable laws; and
in response to claim being denied by the PACE, and the denial of the claim being found arbitrary or capricious by an external independent review organization (IRO) or a court, indemnifying the health care plan fiduciary and paying any damage awarded beyond the initial dollar amount sought by the claim.

2. The method of claim 1, wherein the claim is associated with a pre-service or post-service claim, and wherein the initial dollar amount is either a proposed dollar amount in cases of a pre-service claim or an actual dollar amount in cases of a post-service claim.

3. The method of claim 1, wherein the claim is associated with one or more medical services and/or one or more medical supplies.

4. The method of claim 1, wherein the health care plan fiduciary is a third-party plan administrator (TPA), a plan administrator, a plan sponsor, or other named plan fiduciary.

5. The method of claim 1, wherein the damages awarded beyond the initial dollar amount sought by the claim are up to and including treble damages.

6. The method of claim 1, wherein contracting with a health care plan fiduciary further includes providing example language to the health care plan fiduciary in order to modify an existing plan or to draft a new plan for purposes of using the PACE for the FIA.

7. The method of claim 1, wherein contracting with a health care plan fiduciary further includes determining if a plan provided by the health care plan fiduciary indicates a sufficient number of independent review organizations.

8. A method for providing limited fiduciary services by a Plan Appointed Claim Evaluator (PACE), the method comprising:
contracting with a health care plan fiduciary to provide limited fiduciary services when a final, internal appeal (FIA) of a denial of a pre-service or post-service claim has been sought by a claimant, the claim being associated with an initial dollar amount;
reviewing, by the PACE, the claim in view of the plan associated with the claim and applicable laws; and
in response to claim being denied by the PACE, and the denial of the claim being found arbitrary or capricious by an external independent review organization (IRO) or a court, indemnifying the health care plan fiduciary and paying any damage awarded beyond the initial dollar amount sought by the claim.

9. The method of claim 8, wherein the initial dollar amount is either a proposed dollar amount in cases of a pre-service claim or an actual dollar amount in cases of a post-service claim.

10. The method of claim 8, wherein the claim is associated with one or more medical services and/or one or more medical supplies.

11. The method of claim 8, wherein the health care plan fiduciary is a third-party plan administrator (TPA), a plan administrator, a plan sponsor, or other named plan fiduciary.

12. The method of claim 8, wherein the damages awarded beyond the initial dollar amount sought by the claim are up to and including treble damages.

13. The method of claim 8, wherein contracting with a health care plan fiduciary further includes providing example language to the health care plan fiduciary in order to modify an existing plan or to draft a new plan for purposes of using the PACE for the FIA.

14. The method of claim 8, wherein contracting with a health care plan fiduciary further includes determining if a plan provided by the health care plan fiduciary indicates a sufficient number of independent review organizations.

15. A method for providing limited fiduciary services by a Plan Appointed Claim Evaluator (PACE), the method comprising:
contracting with a health care plan fiduciary to provide limited fiduciary services when a final, internal appeal (FIA) of a denial of a pre-service or post-service claim has been sought by a claimant, the claim being associated with an initial dollar amount;
reviewing, by the PACE, the claim in view of the plan associated with the claim and applicable laws; and
in response to claim being denied by the PACE, and the denial of the claim being found arbitrary or capricious by an external independent review organization (IRO) or a court, indemnifying the health care plan fiduciary and paying any damage awarded beyond the initial dollar amount sought by the claim up to treble damages.

16. The method of claim 15, wherein the initial dollar amount is either a proposed dollar amount in cases of a pre-service claim or an actual dollar amount in cases of a post-service claim.

17. The method of claim 15, wherein the claim is associated with one or more medical services and/or one or more medical supplies.

18. The method of claim 15, wherein the health care plan fiduciary is a third-party plan administrator (TPA), a plan administrator, a plan sponsor, or other named plan fiduciary.

19. The method of claim 15, wherein contracting with a health care plan fiduciary further includes providing example language to the health care plan fiduciary in order to modify an existing plan or to draft a new plan for purposes of using the PACE for final appeal.

20. The method of claim 15, wherein contracting with a health care plan fiduciary further includes determining if a plan provided by the health care plan fiduciary indicates a sufficient number of independent review organizations.
